(19) United States
(12) Patent Application Publication
(10) Pub. No.: US 2011/0056251 A1
(43) Pub. Date: Mar. 10, 2011

(54) Padlock having a storage chamber

(75) Inventor: Takeshi Komiya, Saitama (JP)

(73) Assignee: SHOPIN LOCK CO., LTD., Chang Hua City (TW)

(21) Appl. No.: 12/659,863

(22) Filed: Mar. 24, 2010

(30) Foreign Application Priority Data
Sep. 9, 2009 (TW) 98130444

(51) Int. Cl. E05B 67/02

(52) U.S. Cl. 70/52

(57) ABSTRACT

A padlock includes a casing having a bottom shell and a cover shell pivoted with each other, a shackle movably mounted in the bottom shell, a constraint member movably mounted in the cover shell and having a hook portion for hooking the shackle to lock the cover shell and the bottom shell, and a combination lock unit mounted in the cover shell for controlling the constraint member to determine whether the constraint member is allowable to move away from the shackle.

### BACKGROUND OF THE INVENTION

1. Field of the Invention

The present invention relates to locks and more particularly, to a padlock having a storage chamber.

2. Description of the Related Art

In recent years, number wheel-controlled padlocks having an internal storage chamber are widely accepted by consumers because the padlocks have the advantage of being capable of storing keys, memo pad and other small personal items. A conventional number wheel-controlled padlock generally comprises a casing that includes a bottom shell and a cover shell pivotally connected to the bottom shell and defining with the bottom shell a storage chamber for keeping personal small items. The number wheel-controlled padlock further comprises a shackle, and a combination lock unit for locking/unlocking the shackle, controlling the opening of the casing. When the user rotated the number wheels of the combination lock unit to show a predetermined sequence of numbers, the shackle is unlocked and movable relative to the casing to an unlocked position for allowing removal of the padlock from the attached object. At this time, the cover shell is allowed to be opened from the bottom shell so that the user can put personal items in the storage chamber or take storage items out of the storage chamber.

According to the aforesaid prior design, the padlock is inconvenient to use. When the user wishes to store an item in the storage chamber of the casing or to take one storage item out of the storage chamber, the user must unlock the shackle prior to opening the casing. Further, because the combination lock unit is adapted to lock/unlock the shackle and the casing at the same time, the mechanical design thereof is relatively complicated.

### SUMMARY OF THE INVENTION

The present invention has been accomplished in view of the above-noted circumstances. It is one object of the present invention to provide a padlock having a storage chamber, which controls locking/unlocking of the casing and the shackle separately.

To achieve this object of the present invention, a padlock comprises a casing, a shackle, a latch, a constraint member and a combination lock unit. The casing has a bottom shell provided with a first through hole and a second through hole, and a cover shell pivotally connected to the bottom shell. The shackle has a shackle body and a hook connected to shackle body and provided with an end. The shackle body is inserted through the first through hole of the bottom shell and movable relative to the bottom shell between a first position where the hook is inserted through the second through hole of bottom shell and the end of the hook suspends inside the bottom shell, and a second position where the end of the hook is located outside the bottom shell. The latch is mounted in the bottom shell and movable between an engagement position where the latch engages the end of the hook to stop the shackle body of the shackle from moving away from the first position toward the second position when the shackle body of the shackle is in the first position and a release position where the latch is disengaged from the distal end of the hook for allowing the shackle body of the shackle to be moved from the first position toward the second position. The constraint member has a hook portion and is mounted in the cover shell. The constraint member is movable between a locked position where the hook portion of the constraint member is hooked on one of the shackle and the latch to prohibit biasing of the cover shell relative to the bottom shell and an unlocked position where the hook portion of the constraint member is kept away from the one of the shackle and the latch for allowing the cover shell to be biased relative to the bottom shell. The combination lock unit is mounted in the cover shell for controlling the constraint member to determine whether the constraint is moveable between the locked position and the unlocked position.

As stated above, the padlock uses the latch to control locking and unlocking of the shackle and the combination lock unit to control locking and unlocking of the casing. Thus, the casing of the padlock can be separately opened without opening the shackle, facilitating storing person items in the casing or removal of the storage items from the casing.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a padlock in accordance with a preferred embodiment of the present invention;

FIG. 2 is an exploded view of the padlock in accordance with the preferred embodiment of the present invention;

FIG. 3 is a perspective view of the constraint member according to the preferred embodiment of the present invention;

FIG. 4 is a schematic drawing showing that the cover shell is covered on the bottom shell, the constraint member is positioned at the locked position, and the two hook portions of the constraint member are respectively hooked on the shackle body of the shackle and the protruding rod of the latch;

FIG. 5 is a schematic drawing showing that the shackle body of the shackle and the protruding rod of the latch are forced to push the hook portions of the constraint member such that the constraint member is moved toward the unlocked position during opening of the cover shell from the bottom shell;

FIG. 6 is a schematic drawing showing that the constraint member is positioned at the locked position, and the notches of the number wheels are aligned in line and respectively aimed at the protruding blocks of the constraint member;

FIG. 7 is a schematic drawing showing that the constraint member is positioned at the unlocked position and the protruding blocks of the constraint member are moved into the notches of the number wheels;

FIG. 8 is a schematic drawing showing that the cover shell is opened from the bottom shell, the latch is positioned at the engagement position, and the shackle body of the shackle is positioned at the first position, and

FIG. 9 is a schematic drawing showing that the cover shell is opened from the bottom shell, the latch is positioned at the release position, and the shackle body of the shackle is positioned at the second position.

### DETAILED DESCRIPTION OF THE INVENTION

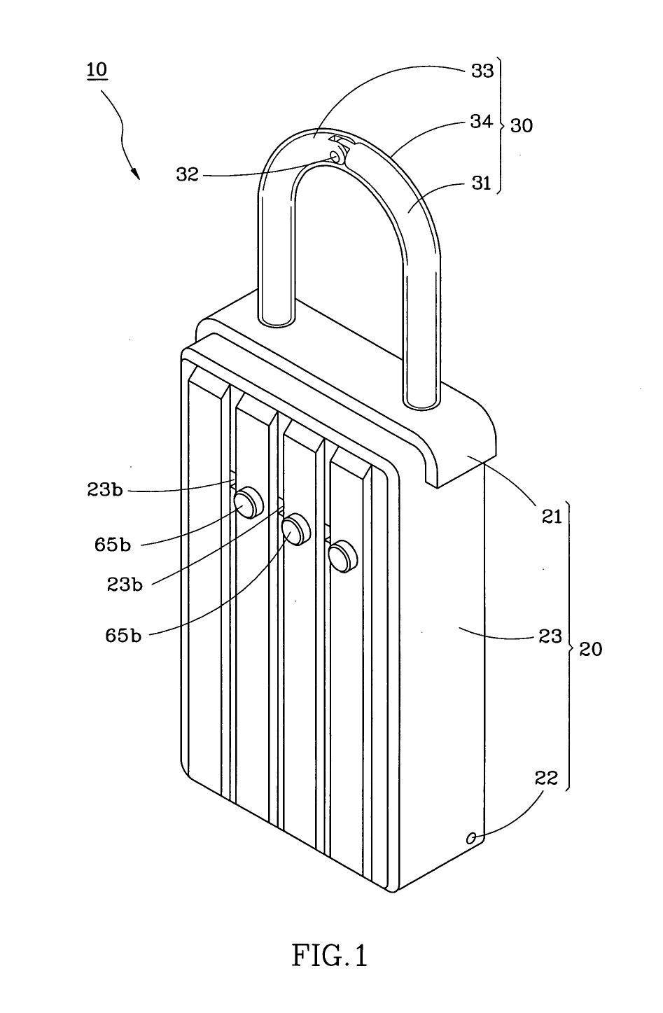

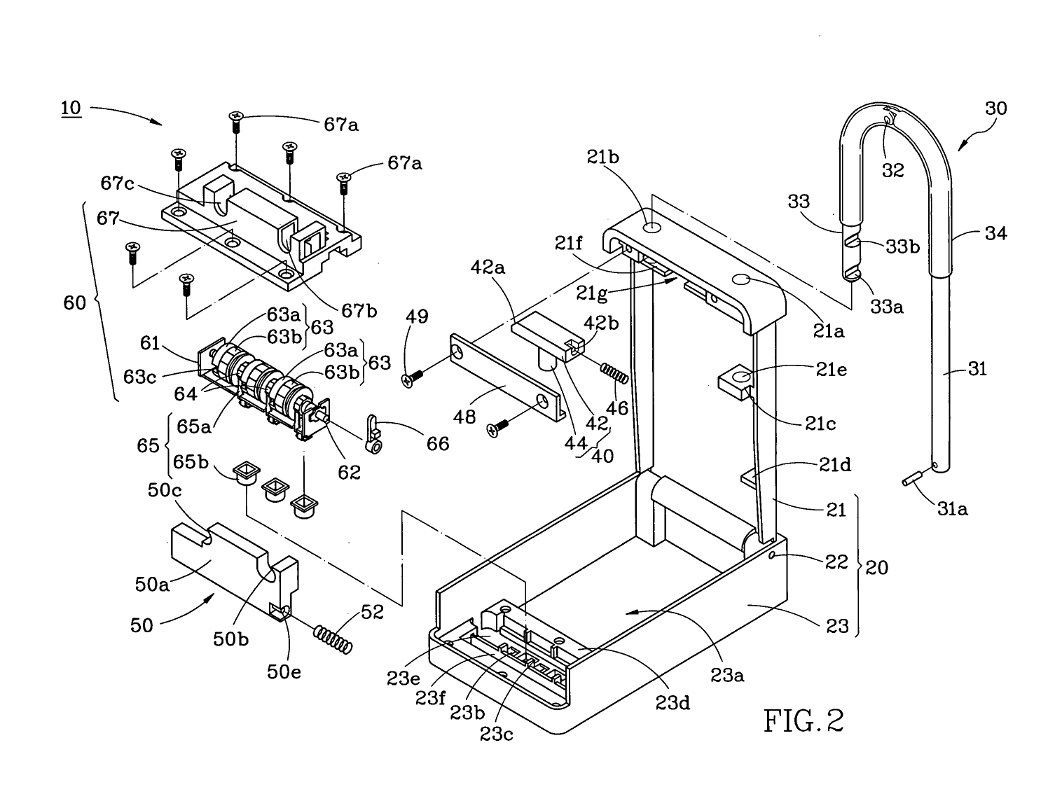

Referring to FIGS. 1-3, a padlock 10 in accordance with a preferred embodiment of the present invention is shown comprising a casing 20, a shackle 30, a latch 40, a constraint member 50 and a combination lock unit 60.

The casing 20 comprises a bottom shell 21 and a cover shell 23, which has its one side, namely, the bottom side pivotally connected to one side, namely, the bottom side of the bottom shell 21 by a pivot pin 22 and biasable relative to the bottom shell 21 to close or open the bottom shell 21. The cover shell 23 defines therein a storage chamber 23a for keeping the user's small personal items such as keys, memo pad and etc. The bottom shell 21 comprises a first through hole 21a and a second through hole 21b on the other side, namely, the top side thereof in communication with inside space, an upper stop block 21c and a lower stop block 21d arranged on the inside at one lateral side, namely, the right side, the upper stop block 21c having a through hole 21e in axial alignment with the first through hole 21a, an elongated latch accommodation chamber 21f located on the top side and provided with an opening 21g facing downwardly. The cover shell 23 comprises three view holes 23b and three button holes 23c cut through the inner and outer walls thereof and arranged in a staggered manner on the middle near the top side, a locating frame 23d located on the inner wall in a predetermined shape adjacent to the top side and defining a combination lock unit accommodation chamber 23e and a constraint member accommodation chamber 23f.

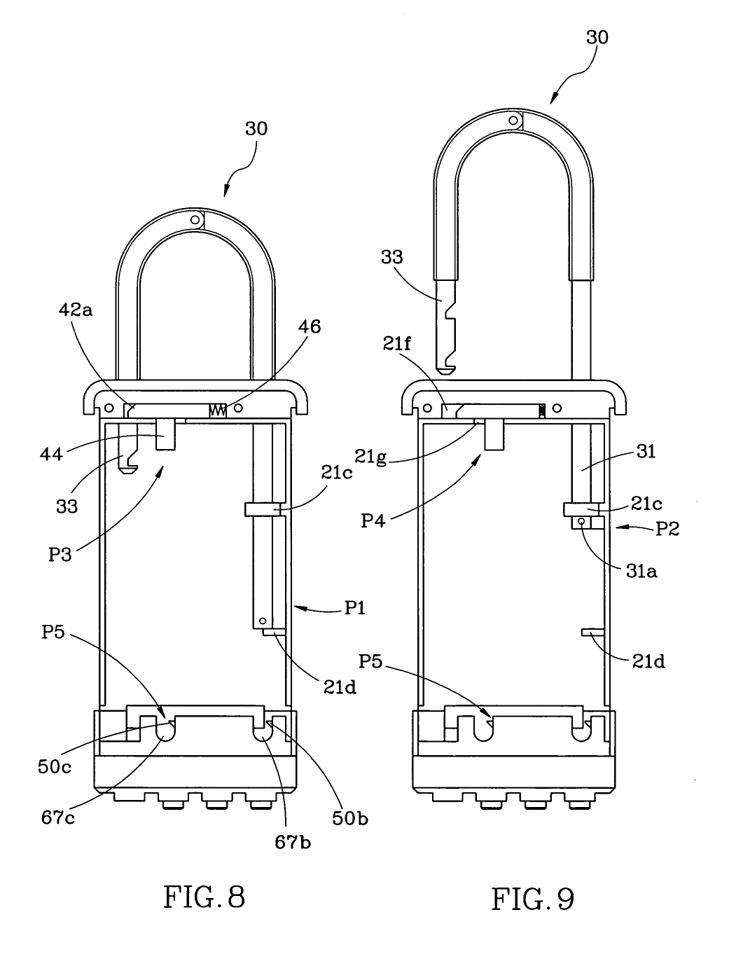

The shackle 30 comprises a shackle body 31, a hook 33 pivotally connected to one end of the shackle body 31 by a pin 32, a transparent flexible plastic sleeve 34 sleeved onto the shackle body 31 and the hook 33. The hook 33 is provided at a free end thereof with a first locating notch 33a and a second locating notch 33b spaced from each other. The shackle body 31 is inserted through the first through hole 21a and the through hole 21e of the upper stop block 21c into the inside of the bottom shell 21, and movable relative to the bottom shell 21 between a first position P1 (see FIG. 8) and a second position P2 (see FIG. 9). When the shackle body 31 is moved to the first position P1, the free end of the hook 33 passes through the second through hole 21b and is suspended inside the bottom shell 21. When the shackle body 31 is moved to the second position P2, the free end of the hook 33 is moved out of the second through hole 21b to the outside of the bottom shell 21. Further, the free end of the shackle body 31 is mounted with a stop pin 31a. As shown in FIG. 9, when the shackle body 31 is moved upwards relative to the bottom shell 21, the stop pin 31a will be stopped at the upper stop block 21c to keep the shackle body 31 in the upper limit position, i.e., the second position P2, avoiding falling of the shackle body 31 out of the bottom shell 21. Further, as shown in FIG. 8, when the shackle body 31 is moved downwards relative to the bottom shell 21, the free end of the shackle body 31 is stopped against the lower stop block 21d to keep the shackle body 31 in the lower limit position, i.e., the first position P1.

The latch 40 comprises a latch body 42 and a protruding rod 44 perpendicularly outwardly extending from a middle part of the latch body 42. The latch body 42 has one end beveled, forming an engagement end 42a. The other end of the latch body 42 is configured to provide a spring mounting rod 42b. The latch 40 is mounted in the latch accommodation chamber 21f of the bottom shell 21 and movable between an engagement position P3 (see FIG. 8) and a release position (see FIG. 9). Further, the protruding rod 44 is inserted through the opening 21g of the latch accommodation chamber 21f and exposed to the inside of the bottom shell 21. Further, a spring member 46 is mounted in the latch accommodation chamber 21f. The spring member 46 has its one end sleeved onto the spring mounting rod 42b of the latch body 42 and stopped against a part of the latch body 42, and its other end stopped against an inside wall of the latch accommodation chamber 21f. Thus, the spring member 46 imparts a spring force to the latch 40, keeping the latch 40 in the engagement position P3 normally. Further, when the latch 40 is forced by an external force to move from the engagement position P3 toward the release position P4, for example, when the user holds the protruding rod 44 to move the latch 40 from the engagement position P3 toward the release position P4, the spring member 46 is compressed (see FIG. 9). When the applied force is released from the latch 40, the spring member 46 imparts a return force to the latch 40 to move the latch 40 back to the engagement position P3. Further, a cover plate 48 is affixed to the inner wall of the top side of the bottom shell 21 by screws 49 to close the latch accommodation chamber 21f, avoiding falling of the latch 40 and the spring member 46 out of the latch accommodation chamber 21f.

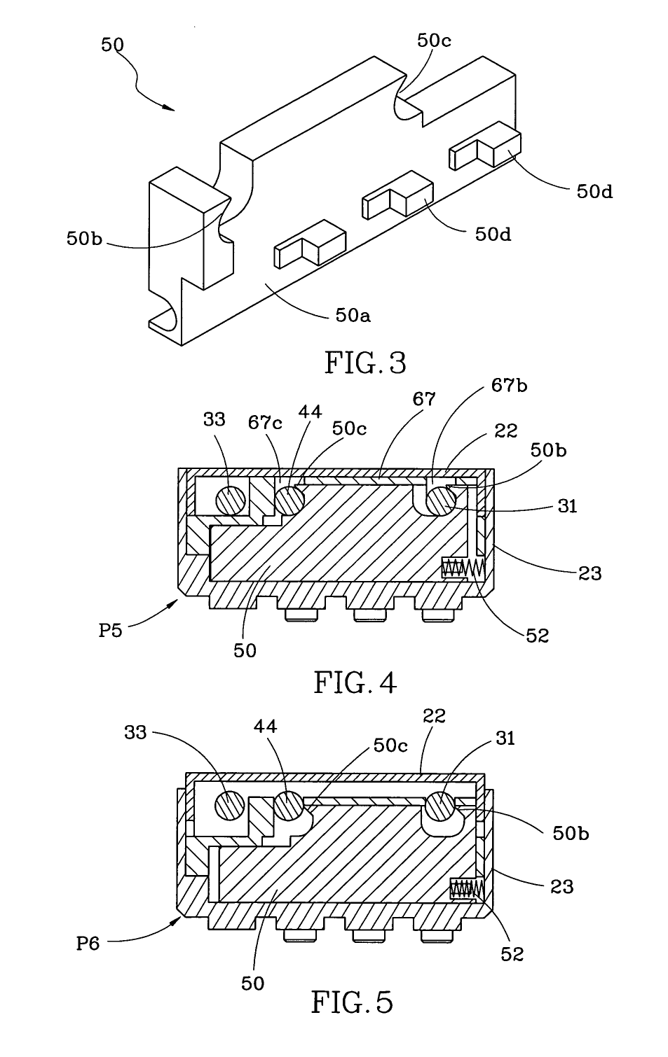

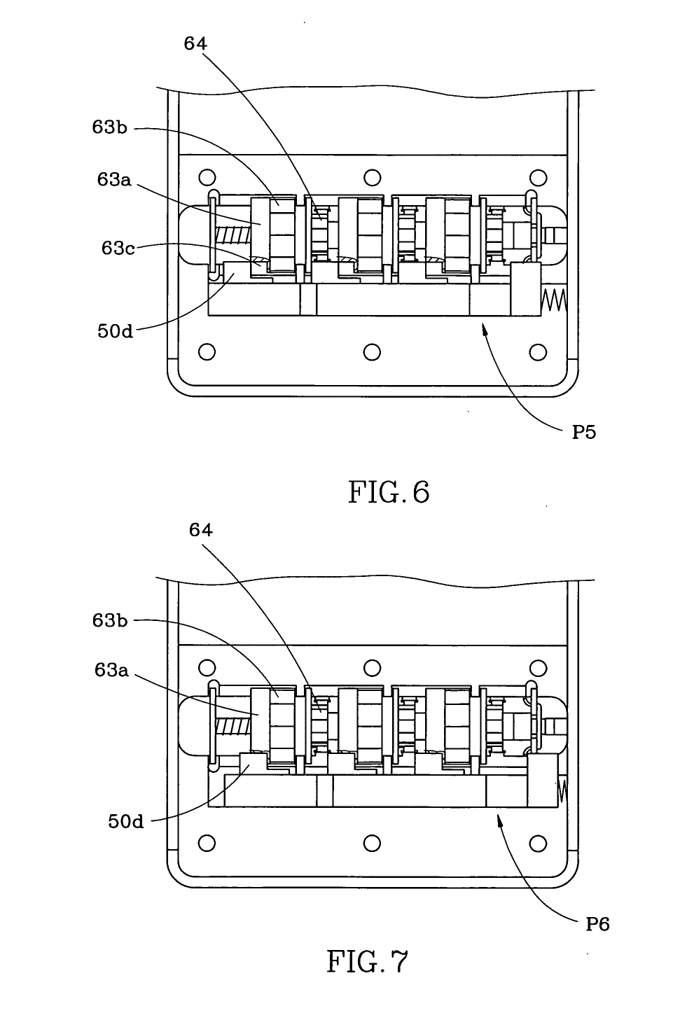

Referring to FIG. 3, the constraint member 50 is a single piece block member having substantially a rectangular shape. The constraint member 50 comprises a block body 50a. The block body 50a has a first hook portion 50b and a second hook portion 50c disposed at the top side thereof and spaced from each other at a predetermined distance, three protruding blocks 50d spaced on the back side thereof and a spring mounting rod 50e located on one end thereof. The constraint member 50 is mounted in the constraint member accommodation chamber 23f of the cover shell 23 and movable between a locked position P5 (see FIG. 4 and FIG. 6) and an unlocked position P6 (see FIG. 5 and FIG. 7). A spring member 52 is mounted in the constraint member accommodation chamber 23f. The spring member 52 has its one end sleeved onto the spring mounting rod 50e and stopped against a part of the block body 50a and its other end stopped against the cover shell 23. Thus, the spring member 52 imparts a pressure to the constraint member 50, keeping the constraint member 50 in the locked position P5 normally.

The combination lock unit 60 is mounted in the combination lock unit accommodation chamber 23e and adapted to control the constraint member 50, deciding whether or not to allow movement of the constraint member 50 between the locked position P5 and the unlocked position P6. The combination lock unit 60 comprises a metal rack 61 mounted inside the combination lock unit accommodation chamber 23e, a shaft 62 mounted on the rack 61, three number wheels 63 rotatably mounted on the shaft 62, three ratchet wheels 64 rotatably mounted on the shaft 62, three ratchet wheel driving units 65, a shifting lever 66 connected to one end of the shaft 62 and a combination lock unit guard plate 67.

Each number wheel 63 comprises a wheel body 63a and a ring 63b mounted on the wheel body 63a inscribed with a series of numerals (not shown) on the periphery. The wheel body 63a has a notch 63c on one side edge thereof at a predetermined location. When the number wheels 63 are rotated to show a predetermined sequence of numbers, the notches 63c of the wheel bodies 63a of the number wheels 63 are aligned in line and respectively aimed at the protruding blocks 50d of the constraint member 50 (see FIG. 6), allowing the protruding blocks 50d to be moved into the notches 63c.

The ratchet wheels 64 are respectively affixed to the number wheels 63 at one side so that rotating one ratchet wheel 64 causes the associated number wheel 63 to be rotated.

The ratchet wheel driving units 65 are respectively mounted in the rack 61 corresponding to the ratchet wheels 64, each comprising a driving rod (not shown), a pawl 65a and a button 65b. Pressing the driving rod causes the driving rod to push and rotate the associated ratchet wheel 64, and therefore the associated number wheel 63 is rotated with the ratchet wheel 64. The pawl 65a engages the associated ratchet wheel 64, stopping the associated ratchet wheel 64 in position. Each button 65b is affixed to the associated driving rod, and inserted through one button hole 23c of the cover shell 23 and exposed to the outside of the cover shell 23 for pressing by the user. The user can see the number exposed by the respective number wheel 63 through one view hole 23b.

The relationship among the number wheels 63, ratchet wheels 64, ratchet wheel driving units 65 and shifting lever 66 of the combination lock unit 60 and their operation principle are obvious to any person skilled in the art, and therefore no further detailed description in this regard is necessarily presented hereunder.

The combination lock unit guard plate 67 is fixedly fastened to the locating frame 23d inside the cover shell 23 by screws 67a to prohibit falling of the constraint member 50, the spring member 52 and the combination lock unit 60 out of the locating frame 23d. The combination lock unit guard plate 67 has a first locating hole 67b and a second locating hole 67c. When the constraint member 50 is in the locked position P5, the first hook portion 50b and second hook portion 50c of the constraint member 50 respectively extend to the first locating hole 67b and the second locating hole 67c (see FIG. 8). When the constraint member 50 is in the unlocked position P6, the first hook portion 50b and second hook portion 50c of the constraint member 50 are respectively concealed inside the combination lock unit guard plate 67 (see FIG. 5).

After understanding of the structure of the component parts of the padlock 10 and their relationship, the operation and effects of the padlock 10 are outlined hereinafter with reference to FIGS. 4-9,

When the padlock 10 is locked (see FIG. 1), i.e., when the shackle 30 is in the first position P1, the cover shell 23 is closed on the bottom shell 21 and the number wheels 63 are rotated to a number combination that does not open the lock, as shown in FIG. 4, the shackle body 31 of the shackle 30 and the protruding rod 44 of the latch 40 are respectively received in the first locating hole 67b and second locating hole 67c of the combination lock unit guard plate 67 and hooked in place by the first hook portion 50b and second hook portion 50c of the constraint member 50 (in the locked position P5), and at this time, the protruding blocks 50d of the constraint member 50 are respectively stopped against the wheel bodies 63a of the number wheels 63, therefore the constraint member 50 is held in the locked position P5 and prohibited from movement toward the unlocked position P6, keeping the padlock 10 in the locked status.

When wanting to unlock the padlock 10, the user can press the respective buttons 65b to move the respective number wheels 63 to the position where the number wheels 63 show a predetermined sequence of numbers. At this time, the notches 63c of the number wheels 63 are aligned in line and respectively aimed at the protruding blocks 50d of the constraint member 50 (see FIG. 6). Thereafter, the user can pull the cover shell 23 outwards from bottom shell 21. At this time, the shackle body 31 of the shackle 30 and the protruding rod 44 of the latch 40 are moved away from the first locating hole 67b and the second locating hole 67c respectively and forced against the first hook portion 50b and second hook portion 50c of the constraint member 50 to move the constraint member 50 from the locked position P5 to the unlocked position P6 (see FIG. 5). At this time, the protruding blocks 50d of the constraint member 50 are respectively moved into the notches 63c of the number wheels 63 (see FIG. 7). Thus, the first hook portion 50b and the second hook portion 50c can be moved away from the shackle body 31 of the shackle 30 and the protruding rod 44 of the latch 40 so that the cover shell 23 can be continuously turned outwards from the bottom shell 21 to open the storage chamber 23a (see FIG. 8).

After the storage chamber 23a is opened, the user can hold the protruding rod 44 of the latch 40 and move the latch 40 from the engagement position P3 to the release position P4 to disengage the engagement end 42a from the second locating notch 33b of the hook 33. At this time, the user can pull the shackle 30 outwards to shift the shackle body 31 from the first position P1 to the second position P2 and to have the free end of the hook 33 be moved out of the bottom shell 21, thereby opening the shackle 30. Thereafter, the user can release the latch 40 to let the latch 40 be returned by the spring member 46 to the engagement position P3.

When wanting to lock the shackle 30 again after the shackle 30 has been opened, the user can push the shackle 30 from the second position P2 toward the first position P1, at this time the free end of the hook 33 is moved into the second through hole 21b of the bottom shell 21 forced against the engagement end 42a of the latch 40, moving the latch 40 from the engagement position P3 toward the release position P4 for allowing the free end of the hook 33 to be continuously moved to the deep inside of the bottom shell 21 to the first position P1 where the shackle 30 is stopped in place. Thereafter, the latch 40 will be returned by the spring member 46 to the engagement position P3 where the engagement end 42a is forced into engagement with the first locating notch 33b of the hook 33 to lock the shackle 30.

When closing the cover shell 23 on the bottom shell 21 at this time, the first hook portion 50b and second hook portion 50c of the constraint member 50 are moved with the constraint member 50 away from the first locating hole 67b and second locating hole 67c of the combination lock unit guard plate 67 by the actuation of the shackle body 31 and the protruding rod 44 toward the unlocked position P6 until the shackle body 31 and the protruding rod 44 have been fully received in the first locating hole 67b and the second locating hole 67c. At this moment, the constraint member 50 will be pushed back to the locked position P5 by the spring member 52 to make the first hook portion 50b and the second hook portion 50c hook on the shackle body 31 and the protruding rod 44 respectively. Thereafter, the user can press the buttons 65b to rotate the number wheels 63 to show a different sequence of numbers not to open the lock, and therefore the cover shell 23 and the bottom shell 21 are locked and cannot be opened.

As stated above, the padlock 10 has functions for allowing the casing 20 and the shackle 30 to be separately opened or locked. The user can press the buttons 65b to rotate the number wheels 63 to show the predetermined sequence of numbers for allowing opening of the cover shell 23. After opened the cover shell 23, the user can hold the protruding rod 44 of the latch 40 and move the latch 40 to the release position P4 to unlock the shackle 30, i.e., the casing 20 of the padlock 10 can be separately opened without opening the shackle 30, facilitating access to storage items.

In the aforesaid preferred embodiment, the constrain member 50 is made having one first hook portion 50b and one second hook portion 50c for hooking the shackle body 31 of the shackle 30 and the protruding rod 44 of the latch 40 respectively, enhancing locking stability. However, in actual practice, the constraint member 50 can be designed having only one hook portion, for example, having only the first hook portion 50b or the second hook portion 50c for hooking the shackle body 31 of the shackle 30 or the protruding rod 44 of the latch 40, achieving the same effect of locking the cover shell 23 to the bottom shell 21. Further, in the aforesaid preferred embodiment, the combination lock unit 60 comprises a ratchet wheel driving unit 65 for allowing the user to rotate the number wheels 63 by pressing the associated buttons 65b. However, this combination lock design is not a limitation, for example, the ratchet wheels 64 and the ratchet wheel driving unit 65 can be omitted and the number wheels 63 can be exposed to the outside of the cover shell 23 for rotation by the user directly to lock or unlock the combination lock unit 60

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A padlock, comprising:
a casing having a bottom shell provided with a first through hole and a second through hole, and a cover shell pivotally connected to the bottom shell;
a shackle having a shackle body and a hook connected to shackle body and provided with an end, the shackle body being inserted through the first through hole of the bottom shell and movable relative to the bottom shell between a first position where the hook is inserted through the second through hole of bottom shell and the end of the hook suspends inside the bottom shell, and a second position where the end of the hook is located outside the bottom shell;
a latch mounted in the bottom shell and movable between an engagement position where the latch engages the end of the hook to stop the shackle body of the shackle from moving away from the first position toward the second position when the shackle body of the shackle is in the first position and a release position where the latch is disengaged from the distal end of the hook for allowing the shackle body of the shackle to be moved from the first position toward the second position;
a constraint member having a hook portion, the constraint member being mounted in the cover shell and movable between a locked position where the hook portion of the constraint member is hooked on one of the shackle and the latch to prohibit biasing of the cover shell relative to the bottom shell and an unlocked position where the hook portion of the constraint member is kept away from the one of the shackle and the latch for allowing the cover shell to be biased relative to the bottom shell; and
a combination lock unit mounted in the cover shell for controlling the constraint member to determine whether the constraint is moveable between the locked position and the unlocked position.

2. The padlock as claimed in claim 1, wherein the combination lock unit comprises a plurality of rotatable number wheels, each the number wheel comprising a notch, the notches of the number wheels being aligned in line when the number wheels are rotated to show a predetermined sequence of numbers; the constraint member comprises a plurality of protruding blocks respectively stopped against wheel bodies of the number wheels, the protruding blocks of the constraint member being movable into the notches of the number wheels for enabling the constraint member to be moved from the locked position toward the unlocked position when the notches of the number wheel are aligned in line.

3. The padlock as claimed in claim 2, wherein when the constraint member is in the locked position, the hook portion of the constraint member is hooked on the shackle body of the shackle; when the constraint member is in the unlocked position, the hook portion of the constraint member is kept away from the shackle body of the shackle.

4. The padlock as claimed in claim 3, wherein the latch comprises a protruding rod for holding by the user to move the latch from the engagement position toward the release position.

5. The padlock as claimed in claim 4, wherein the constraint member further comprises a second hook portion, the second hook portion being hooked on the protruding rod of the latch when the constraint member is in the locked position, the second hook portion being kept away from the protruding rod of the latch when the constraint member is in the unlocked position.

6. The padlock as claimed in claim 5, further comprising a spring member stopped between the constraint member and the cover shell to keep the constraint member in the locked position normally.

7. The padlock as claimed in claim 6, further comprising a spring member stopped between the latch and the bottom shell to keep the latch in the engagement position normally.

8. The padlock as claimed in claim 7, wherein the hook of the shackle comprises a locating notch for the engagement of one end of the latch.

9. The padlock as claimed in claim 8, wherein the cover shell comprises a plurality of button holes; the combination lock unit comprises:
a rack fixedly mounted in the cover shell;
a shaft mounted in the rack; the number wheels being spacedly and rotatably sleeved on the shaft;
a plurality of ratchet wheels rotatably mounted on the shaft and respectively affixed to the number wheels at one side;
a plurality of ratchet wheel driving units mounted on the rack corresponding to the ratchet wheels, each the ratchet wheel driving unit comprising:
a driving rod pressable to move one said ratchet wheel for rotating an associated number wheel;
a pawl for engaging one said ratchet; and
a button affixed to the driving rod and extending through one said button hole to the outside of the cover shell for pressing by the user.

10. The padlock as claimed in claim 2, wherein the latch comprises a protruding rod; the hook portion of the constraint member is hooked on the protruding rod of the latch when the constraint member is in the locked position, and the hook portion of the constraint member is kept away from the protruding rod of the latch when the constraint member is in the unlocked position.
